(19) United States
(12) Patent Application Publication
(10) Pub. No.: US 2024/0173936 A1
(43) Pub. Date: May 30, 2024

(54) MULTILAYER TUBE

(71) Applicant: Sumitomo Riko Company Limited, Aichi (JP)

(72) Inventors: Masashi OKAHISA, Aichi (JP); Koji MIZUTANI, Aichi (JP); Yorihiro TAKIMOTO, Aichi (JP); Kazuhiro SAIKI, Aichi (JP)

(73) Assignee: Sumitomo Riko Company Limited, Aichi (JP)

(21) Appl. No.: 18/434,033

(22) Filed: Feb. 6, 2024

Related U.S. Application Data
(63) Continuation of application No. PCT/JP2022/044346, filed on Dec. 1, 2022.

(30) Foreign Application Priority Data
Dec. 14, 2021 (JP) 2021-202598

(51) Int. Cl. B32B 1/08; B32B 3/30; B32B 27/08; B32B 27/20; B32B 27/32; B32B 27/34

(52) U.S. Cl. CPC B32B 1/08; B32B 3/30; B32B 27/08; B32B 27/20; B32B 27/32; B32B 27/34; B32B 2250/02; B32B 2250/24; B32B 2264/302; B32B 2264/303; B32B 2264/50; B32B 2307/7375

(57) ABSTRACT

Provided is a multilayer tube with excellent strength, heat resistance, and the like, further exhibiting excellent interlayer adhesion without an adhesive, as well as good interlayer adhesion after annealing. The multilayer tube has a tubular inner layer and an outer layer formed on an outer peripheral surface thereof. The inner layer is a maleic anhydride-modified polypropylene resin layer which contains organic particles having an average particle size of 0.1-10 μm. The outer layer is a polyamide resin layer with an amine value of 15-100 mmol/kg. The multilayer tube includes numerous convex protrusions caused by the organic particles on a side of the inner layer at an interface between the inner layer and the outer layer.

### RELATED APPLICATIONS

This application is a continuation of International Application No. PCT/JP2022/044346, filed on Dec. 1, 2022, which claims priority to Japanese Patent Application No. 2021-202598, filed on Dec. 14, 2021, the entire contents of each of which are herein incorporated by reference.

### TECHNICAL FIELD

The present disclosure mainly relates to a multilayer tube used for piping of a cooling system inside a vehicle such as an automobile.

### BACKGROUND ART

Conventionally, a polyamide resin has been employed as a piping material for a cooling system inside a gasoline-powered vehicle because of its excellent strength and heat resistance. In addition, a polyamide resin similar to those for a gasoline-powered vehicle has conventionally been employed as a piping material for a cooling system inside an electric automobile as well.

In recent years, the need for cooling inside of an electric automobile has been increasing as electrification of a vehicle such as an automobile has progressed.

However, a tube made of a polyamide resin has problems in terms of a price. Therefore, in order to solve the above-mentioned problems, the use of a tube utilizing an inexpensive polypropylene resin has also been considered.

Furthermore, a low cost and high functional tube has also been considered, where a polyamide resin layer and a polypropylene resin layer are laminated, thereby taking advantage of properties of both layers (see PTL 1 and PTL 2).

### RELATED ART DOCUMENT

### Patent Document

PTL 1: JP-B2-4909267
PTL 2: JP-A-2012-82885

### SUMMARY

### Problems to be Solved by the Disclosure

However, interlayer adhesion of a polypropylene resin layer to a polyamide resin layer is low. Without sufficient interlayer adhesion, an outer layer of a tube cannot be protected, causing problems such as the tube being more likely to rupture due to internal pressure of a fluid flowing inside the tube. Additionally, when a multilayer tube as described above is subjected to bending and the like, annealing (heat treatment) is performed at a temperature near a melting point of a resin of each layer, so that there are also problems such as the interlayer adhesion being more likely to deteriorate on that occasion.

Accordingly, it is conceived to apply an adhesive between a polyamide resin layer and a polypropylene resin layer to bond them, but this is problematic in terms of an operation cost and the like associated with the bonding.

Furthermore, in the tube disclosed in PTL2, a maleic anhydride-modified polypropylene resin layer is used as the polypropylene resin layer, thereby enhancing adhesion to the polyamide resin layer, but there still remain problems such as the interlayer adhesion being more likely to decrease due to annealing (heat treatment) performed upon bending a multilayer tube and the like. Therefore, there is still room for improvement in this respect.

The present disclosure has been made in view of such circumstances, and an object of the present disclosure is to provide a multilayer tube with excellent strength, heat resistance, and the like, further exhibiting excellent interlayer adhesion without an adhesive as well as good interlayer adhesion after annealing.

### Means for Solving the Problems

The inventors have made extensive investigations in order to solve the above-mentioned problems. In the course of the investigations, the inventors have made an investigation on improvement in interlayer adhesion of a tube having a laminated structure of a maleic anhydride-modified polypropylene resin layer and a polyamide resin layer, through various experiments.

As a result, it was conceived to use a polyamide resin with an amine value of 15-100 mmol/kg as a polyamide resin in the polyamide resin layer, and further add organic particles having a specific particle size to a material for the polypropylene resin layer, such that by devising a manufacturing method or the like, numerous convex protrusions caused by the organic particles appeared on a side of the polypropylene resin layer at an interface between the polyamide resin layer and the polypropylene resin layer.

In this manner, it was found that a chemical bond between an amino group of the polyamide resin and a maleic anhydride-modified group of the polypropylene resin improved interlayer adhesion between both layers; and further, an anchoring effect (anchor effect) by the convex protrusions increased contact area between both layers and also improved a friction force, which would provide more effective interlayer adhesion. Accordingly, it was found that even without an adhesive (adhesiveless), it was possible to improve the interlayer adhesion between both layers, and further solve the problems such as decrease in the interlayer adhesion due to annealing and the resulting tube rupture.

That is, the summary of the present disclosure is as following [1]-[6].
[1] A multilayer tube comprising a layered structure in which a polypropylene resin layer and a polyamide resin layer are laminated in direct contact with each other,
   wherein a polypropylene resin in the polypropylene resin layer is maleic anhydride-modified polypropylene, the polypropylene resin layer containing organic particles having an average particle size of 0.1-10 μm,
   wherein a polyamide resin in the polyamide resin layer is a polyamide resin with an amine value of 15-100 mmol/kg, and
   wherein the multilayer tube has a plurality of convex protrusions caused by the organic particles on a side of the polypropylene resin layer at an interface between the polypropylene resin layer and the polyamide resin layer.
[2] The multilayer tube as defined in [1], wherein a height of the convex protrusions is in a range of 0.1-10 μm.
[3] The multilayer tube as defined in [1] or [2], wherein the number of the convex protrusions in a straight-line distance at the interface between the polypropylene resin layer and the polyamide resin layer is 2-20 per 100 μm.
[4] The multilayer tube as defined in any one of [1]-[3], wherein a ratio of the organic particles in the polypropylene resin layer is 5-20% by mass.
[5] The multilayer tube as defined in any one of [1]-[4], wherein the organic particles consist of at least one of polyethylene and an ethylene-propylene copolymer.
[6] The multilayer tube as defined in any one of [1]-[5], wherein the polypropylene resin layer is an inner layer and the polyamide resin layer is an outer layer.

### Effects of the Disclosure

Accordingly, the multilayer tube of the present disclosure has excellent strength, heat resistance, and the like, and can exhibit excellent interlayer adhesion even without an adhesive and further good interlayer adhesion even when annealing is performed. Therefore, it is possible to solve the problems such as decrease in the interlayer adhesion due to annealing and the resulting tube rupture.

### BRIEF DESCRIPTION OF DRAWINGS

FIG. 1 is a diagram illustrating one example of a multilayer tube according to the present disclosure.

FIG. 2 is a schematic view illustrating a laminated state of a multilayer tube according to the present disclosure.

### EMBODIMENTS OF THE DISCLOSURE

Next, embodiments of the present disclosure will be described in detail. However, the present disclosure is not limited to these embodiments.

Note that in the present disclosure, “X-Y” (X and Y are arbitrary numbers) as described herein means, unless otherwise specified, “equal to or greater than X and equal to or less than Y”, as well as “preferably greater than X” or “preferably less than Y”.

A multilayer tube according to one embodiment of the present disclosure (hereinafter referred to as “present multilayer tube”) is a tube having a structure in which a polypropylene resin layer and a polyamide resin layer are laminated in direct contact with each other as described above. Further, a polypropylene resin in the polypropylene resin layer is maleic anhydride-modified polypropylene, the polypropylene resin layer containing an organic particle having an average particle size of 0.1-10 μm, and a polyamide resin in the polyamide resin layer is a polyamide resin with an amine value of 15-100 mmol/kg. Furthermore, the multilayer tube has numerous convex protrusions caused by the organic particle on a side of the polypropylene resin layer at an interface between the polypropylene resin layer and the polyamide resin layer.

Here, FIG. 2 schematically shows the interface between the polypropylene resin layer and the polyamide resin layer. That is, in FIG. 2, 1 denotes the polypropylene resin layer, 2 denotes the polyamide resin layer, and 3 denotes the organic particle. As shown, there are numerous convex protrusions 1a caused by the organic particles 3 on the side of the polypropylene resin layer 1 at the interface between the polypropylene resin layer 1 and the polyamide resin layer 2.

The average particle size of the organic particle 3 in the polypropylene resin layer 1 is in the range of 0.1-10 μm as described above, preferably in the range of 0.1-5 μm, and more preferably in the range of 0.3-3 μm. That is, by exhibiting such average particle size, numerous convex protrusions 1a of a desired size can be developed on the side of the polypropylene resin layer 1 at the interface, and the anchoring effect (anchor effect) thereof increases contact area between both layers and also improves a friction force, allowing improvement in the interlayer adhesion between both layers.

Note that the average particle size of the organic particle 3 is obtained by cutting the multilayer tube in half, capturing an image of the laminated cross section thereof by a scanning electron microscope (SEM) at a magnification of 5000 times, and measuring the particle size of any ten organic particles 3 confirmed in the polypropylene resin layer 1 based on the image to calculate the average.

In addition, a height of the convex protrusions 1a (distance between a peak and a bottom at an interface between a concave and a convex) is preferably in the range of 0.1-10 μm, and more preferably in the range of 0.1-5 μm.

Further, the number of the convex protrusions 1a in a straight-line distance at the interface between the polypropylene resin layer 1 and the polyamide resin layer 2 is preferably 2-20 per 100 μm, and more preferably 3-15 per 100 μm.

That is, it is preferable to satisfy these specifications so that the anchoring effect and the like by the convex protrusions 1a becomes higher, allowing improvement in the interlayer adhesion between both layers.

Note that these measurements are performed by cutting the multilayer tube in half, capturing images of the laminated cross section thereof by a scanning electron microscope (SEM) at a magnification of 5000 times, and measuring based on the ten connected images.

Next, materials for the polypropylene resin layer 1 and the polyamide resin layer 2 will be described.

<Material for Polypropylene Resin Layer 1>

A polypropylene resin to be used as the material for forming the polypropylene resin layer 1 is maleic anhydride-modified polypropylene as described above. Note that 50% by mass or more of the material for the polypropylene resin layer 1 is made up of the maleic anhydride-modified polypropylene, including also a case where the material for forming the polypropylene resin layer 1 other than the organic particle 3 may consist only of the maleic anhydride-modified polypropylene.

Further, amount of modification of the maleic anhydride-modified polypropylene is preferably 0.05-7% by mass, and more preferably 0.1-5% by mass. That is because, when the amount of modification is too low, interlayer adhesion tends to deteriorate, whereas when the amount of modification is too high, heat resistance tends to be worse.

In addition, the maleic anhydride-modified polypropylene preferably has a melting point of 130-180° C., and more preferably 140-170° C. That is because, when the melting point is too low, the heat resistance tends to be worse, whereas when the melting point is too high, the interlayer adhesion tends to deteriorate.

The organic particle 3 contained in the polypropylene resin layer 1 includes a particle consisting of an organic material such as a rubber (ethylene-propylene copolymer, ethylene octene, ethylene butene, ethylene hexene, ethyl acrylate, etc.) and a resin (polyethylene etc.). These can be used alone or in combination of two or more kinds thereof. Among these, an organic particle consisting of at least one of polyethylene and an ethylene-propylene copolymer is preferable from the viewpoint of compatibility. Note that the organic particle 3 may be granulated in advance to satisfy the specific average particle size as described above, and then, added to the material for the polypropylene resin layer 1. Additionally, a resin or a rubber to be used as the material for the organic particle 3 may be melted and kneaded with maleic anhydride-modified polypropylene under a certain condition (melt kneading by a twin screw kneader at 200-250° C. for 1-10 minutes) to pelletize, and then, may be subjected to melt molding extrusion in accordance with the condition described later, thereby causing the organic particle 3 to appear in the polypropylene resin.

A ratio of the organic particle 3 in the polypropylene resin layer 1 is preferably 5-20% by mass, and more preferably 10-15% by mass. That is because, the organic particle 3 contained at such ratio can provide good interlayer adhesion after annealing.

Here, the ratio of the organic particle 3 in the polypropylene resin layer 1 can be obtained before manufacturing the present multilayer tube based on the ratio of the organic particle 3 (alternatively, a resin or a rubber as the material for the organic particle 3) to be mixed in the material for the polypropylene resin layer 1. After manufacturing the present multilayer tube, the ratio can be obtained by capturing an image of the polypropylene resin layer 1 by a scanning electron microscope (SEM) at a magnification of 1000 times and performing binary coded processing and the like.

Note that, in addition to the maleic anhydride-modified polypropylene and the organic particle 3, if necessary, a weathering stabilizer, a lubricant, a pigment, a dye, an antistatic agent, a plasticizer, a heat-resistant antioxidant, or the like can be added to the material for the polypropylene resin layer 1 as appropriate.

Additionally, these materials to be used as the material for the polypropylene resin layer 1 are subjected to melt kneading and pelletized as necessary.

<Material for Polyamide Resin Layer 2>

A polyamide resin used as the material for forming the polyamide resin layer 2 is a polyamide resin with an amine value of 15-100 mmol/kg as described above. Preferably, it is a polyamide resin with an amine value of 20-80 mmol/kg, and more preferably a polyamide resin with an amine value of 25-60 mmol/kg. The use of the polyamide resin having such an amine value can provide excellent interlayer adhesion to the polypropylene resin layer 1 and the like. Note that when the amine value is too low, the interlayer adhesion tends to deteriorate, whereas when the amine value is too high, an extrusion molding property tends to deteriorate.

Here, the amine value of the polyamide resin refers to the number of mmol of amine contained in 1 kg of a solid content of the polyamide resin.

The polyamide resin showing said amine value includes, for example: an aliphatic polyamide resin such as polyamide 46 (PA46), polyamide 410 (PA410), polyamide 6 (PA6), polyamide 66 (PA66), polyamide 610 (PA610), polyamide 612 (PA612), polyamide 11 (PA11), polyamide 12 (PA12), and polyamide 1010 (PA1010); an aromatic polyamide resin such as polyamide 6T (PA6T), polyamide 9T (PA9T), and polyamide 10T (PA10T); or the like. These are used alone or in combination of two or more kinds thereof. Among these, an aliphatic polyamide resin is preferable because of its excellent interlayer adhesion to the polypropylene resin layer 1 and the like.

In addition, the melting point of the polyamide resin is preferably 160-280° C., and more preferably 170-270° C. That is because, when the melting point is too low, the heat resistance tends to be worse, whereas when the melting point is too high, the interlayer adhesion tends to deteriorate.

Note that 50% by mass or more of the material for the polyamide resin layer 2 is made up of the polyamide resin with said amine value, preferably 70% by mass or more of the material for the polyamide resin layer 2 is the polyamide resin with said amine value, and more preferably 100% by mass of the material for the polyamide resin layer 2 is the polyamide resin with said amine value.

Note that, in addition to the polyamide resin with said amine value, if necessary, a weathering stabilizer, a lubricant, a pigment, a dye, an antistatic agent, a plasticizer, a heat-resistant antioxidant, or the like can be added to the material for the polyamide resin layer 2 as appropriate.

Additionally, these materials to be used as the material for the polyamide resin layer 2 are subjected to melt kneading and pelletized as necessary.

In the present multilayer tube, to achieve adhesiveless bonding of the polypropylene resin layer 1 and the polyamide resin layer 2, it is preferable to form both the layers by co-extrusion molding.

Furthermore, it is preferable that in the present multilayer tube, the polypropylene resin layer 1 is an inner layer (inside layer) and the polyamide resin layer 2 is an outer layer (outside layer) in view of hydrolyzability.

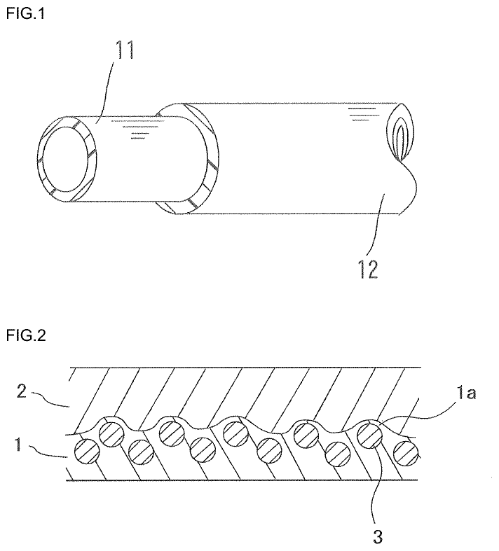

Examples include a multilayer tube having a two-layer structure in which an outer layer 12 is formed directly on an outer peripheral surface of an inner layer 11 as shown in FIG. 1, the inner layer 11 being the same as the polypropylene resin layer 1 and the outer layer 12 being the same as the polyamide resin layer 2.

Further, the same layer as the polypropylene resin layer 1 may be formed on the outer peripheral surface of the outer layer 12, thereby providing a multilayer tube having a three-layer structure.

Yet further, any other resin layer, a rubber layer, or a reinforcing layer (layer formed by braiding reinforcing yarns such as PET yarns, etc.) may further be laminated on the outer peripheral surface of these multilayer tubes.

### <Method for Manufacturing Present Multilayer Tube>

Next, a method for manufacturing the present multilayer tube will be described.

That is, first, a material for the inner layer 11 (material for the polypropylene resin layer 1) is prepared, which is pelletized as appropriate in accordance with the aforementioned condition. In addition, a material for the outer layer 12 (material for the polyamide resin layer 2) is prepared, which is also pelletized as appropriate. Next, using an extrusion molding machine, the material for the inner layer 11 and the material for the outer layer 12 are subjected to melt extrusion molding (co-extrusion molding) onto a mandrel to become a tube shape, thereby forming the outer layer 12 on the outer peripheral surface of the inner layer 11. Note that the mandrel can be omitted as necessary.

In this case, extrusion molding of each layer is performed by the extrusion molding machine at a temperature of 200-350° C. (preferably 220-280° C.) at a take up speed of 1-15 m/min (preferably, 3-5 m/min). Particularly, melt extrusion molding (co-extrusion molding) is preferably performed at a temperature 20-100° C. higher (preferably, 20-80° C. higher) than the melting point of the polyamide resin used as the material for the outer layer 12. That is because manufacturing under such conditions allows organic particles in the inner layer 11 to be unevenly distributed near an interface with the outer layer 12, resulting in numerous convex protrusions of a desired size being developed on the side of the inner layer 11 at the interface.

Then, if necessary, the multilayer tube thus obtained is subjected to annealing (heat treatment) at a temperature near the melting point of the resin of each layer, or bending is performed upon that annealing.

In this manner, it is possible to manufacture the present multilayer tube (see FIG. 1).

In the present multilayer tube thus obtained, an inner diameter of the tube preferably falls within the range of 2-40 mm, and more preferably 4-35 mm. Further, thickness of the inner layer 11 preferably falls within the range of 0.1-1.9 mm, and more preferably 0.2-1.8 mm. Yet further, thickness of the outer layer 12 preferably falls within the range of 0.1-1.9 mm, and more preferably 0.2-1.8 mm.

The present multilayer tube is used as a radiator hose, a heater hose, an air conditioner hose, and the like, as well as a cooling tube of a battery pack for an electric automobile and a fuel cell vehicle. Additionally, the multilayer tube can also be used not only for an automobile, but also for any other transport machines (an industrial transport vehicle such as an airplane, a forklift, an excavator, and a crane, as well as a railway vehicle, etc.) or the like.

### EXAMPLES

Next, Examples will be described together with Comparative Examples. However, the present disclosure is not limited to these Examples.

First, prior to Examples and Comparative Examples, materials for the inner layer (material for the polypropylene resin layer) and materials for the outer layer (material for the polyamide resin layer) as described below were prepared.

### [Material for Inner Layer (A)]

100 parts by mass of maleic anhydride-modified polypropylene (ADMER QF500 manufactured by Mitsui Chemicals, Inc., amount of modification: 0.27% by mass, melting point: 165° C.) and 15 parts by mass of an ethylene-propylene copolymer (TAFMER DF840 manufactured by Mitsui Chemicals, Inc.) were mixed by a twin screw extruder at 200° C.×1 minute to 5 minutes, thereby preparing the material for the inner layer (A)(pellet).

### [Material for Inner Layer (B)]

100 parts by mass of maleic anhydride-modified polypropylene (ADMER QF500 manufactured by Mitsui Chemicals, Inc., amount of modification: 0.27% by mass, melting point: 165° C.) and 15 parts by mass of an ethylene-propylene copolymer (mixture of TAFMER DF840 and TAFMER DF8200 manufactured by Mitsui Chemicals, Inc. at a mass ratio of TAFMER DF840:TAFMER DF8200=8:2) were mixed by a twin screw extruder at 200° C.×1 minute to 5 minutes, thereby preparing the material for the inner layer (B)(pellet).

### [Material for Inner Layer (C)]

100 parts by mass of maleic anhydride-modified polypropylene (ADMER QF500 manufactured by Mitsui Chemicals, Inc., amount of modification: 0.27% by mass, melting point: 165° C.) and 15 parts by mass of an ethylene-propylene copolymer (mixture of TAFMER DF840 and TAFMER DF8200 manufactured by Mitsui Chemicals, Inc. at a mass ratio of TAFMER DF840:TAFMER DF8200=6:4) were mixed by a twin screw extruder at 200° C.×1 minute to 5 minutes, thereby preparing the material for the inner layer (C)(pellet).

### [Material for Inner Layer (D)]

100 parts by mass of maleic anhydride-modified polypropylene (ADMER QF500 manufactured by Mitsui Chemicals, Inc., amount of modification: 0.27% by mass, melting point: 165° C.) and 15 parts by mass of an ethylene-propylene copolymer (mixture of TAFMER DF840 and TAFMER DF8200 manufactured by Mitsui Chemicals, Inc. at a mass ratio of TAFMER DF840:TAFMER DF8200=2:8) were mixed by a twin screw extruder at 200° C.×1 minute to 5 minutes, thereby preparing the material for the inner layer (D)(pellet).

### [Material for Inner Layer (E)]

100 parts by mass of maleic anhydride-modified polypropylene (ADMER QF500 manufactured by Mitsui Chemicals, Inc., amount of modification: 0.27% by mass, melting point: 165° C.) and 15 parts by mass of an ethylene-propylene copolymer (TAFMER DF8200 manufactured by Mitsui Chemicals, Inc.) were mixed by a twin screw extruder at 200° C.×1 minute to 5 minutes, thereby preparing the material for the inner layer (E)(pellet).

### [Material for Inner Layer (F)]

100 parts by mass of maleic anhydride-modified polypropylene (ADMER QF500 manufactured by Mitsui Chemicals, Inc., amount of modification: 0.27% by mass, melting point: 165° C.) and 15 parts by mass of an ethylene-propylene copolymer (TAFMER XM-7070 manufactured by Mitsui Chemicals, Inc.) were mixed by a twin screw extruder at 200° ° C.×1 minute to 5 minutes, thereby preparing the material for the inner layer (F)(pellet).

[Materials for Outer Layer (a)-(e)]

Commercially available polyamide resins shown in Table 1 below were prepared as the materials for the outer layer (a)-(d). Additionally, polyphthalamide (PPA) as the material for the outer layer (e) shown in Table 1 below was prepared as described later.

TABLE 1

| | | | Melting | Amine Value |
|---|---|---|---|---|
| | Product Name | Manufacturer | Point | (mmol/g) |
| Material for outer layer (a) | SX8002 | Daicel-Evonik | 211° C. | 70.7 |
| Material for outer layer (b) | Zytel RSLC3060 | Du Pont | 223° C. | 52.0 |
| Material for outer layer (c) | CM2001 | Toray | 222° C. | 18.0 |
| Material for outer layer (d) | Reny “#6007” | Mitsubishi Engineering | 240° C. | 9.0 |
| Material for outer layer (e) | PPA | — | 320° C. | 110.0 |

[Preparation of Material for Outer Layer (e)(PPA)]

An autoclave with an internal capacity of 13.6 L was charged with 14.9 mol of terephthalic acid, 25 mol of 1,6-hexanediamine, 10 mol of adipic acid, 0.6 mol of benzoic acid, sodium hypophosphite monohydrate, and distilled water, and purged with nitrogen. Then, the internal temperature was raised from 190° ° C. to 250° C. over 3 hours, and the internal pressure was increased to 3.0 MPa.

After continuing the reaction in that state for 1 hour, atmosphere was discharged through a spray nozzle disposed at the bottom of the autoclave, and a low condensate was taken out. Thereafter, the low condensate was pulverized by a pulverizer and dried at 100° C. for 48 hours. The low condensate was purged with nitrogen.

Then, the temperature of the low condensate purged with nitrogen was increased to 220° C. over 1.5 hours in the autoclave, and subjected to a solid phase polymerization reaction for 1 hour in that state, followed by cooling to a room temperature. A prepolymer thus obtained was subjected to melt polymerization using a twin screw extruder with a screw diameter of 30 mm and a ratio of a shaft diameter to a screw shaft length (L/D) of 54, at a cylinder temperature of 330° C., a screw rotation speed of 170 rpm, and a discharge rate of 5 kg/H, thereby obtaining polyphthalamide (PPA) with a melting point of 320° C. and an amine value of 110.0 mmol/g.

### Examples 1-6, Comparative Examples 1-4

Using the combinations shown in Table 2 below, the materials for the inner layer and the materials for the outer layer were subjected to melt extrusion molding (co-extrusion molding) using a multilayer extrusion molding machine capable of co-extrusion molding (multilayer extruder manufactured by Research Laboratory of Plastics Technology Co., Ltd.) at a temperature 20° C. higher than the melting point of each material for the outer layer (each polyamide resin) to become a tube shape, thereby producing a multilayer tube (thickness of the inner layer: 0.6 mm, thickness of the outer layer: 0.4 mm, inner diameter: 12 mm) at a take up speed of 3 m/min.

The multilayer tube thus obtained was cut in half, images of the laminated cross section thereof were captured by a scanning electron microscope (SEM) at a magnification of 5000 times, and the ten images were connected.

Then, based on the images, the particle size of any ten particles of the ethylene-propylene copolymer (organic particles) confirmed in the inner layer was measured to obtain the average particle size (μm) thereof.

Furthermore, in the images, when numerous convex protrusions (protrusions with height of 0.1 μm or greater) caused by the organic particles on the side of the inner layer at the interface between the inner layer and the outer layer were recognized, the number of the convex protrusions (per 100 μm) was counted in a straight-line distance at the interface.

The results thereof are also shown in Table 2 below.

Then, for the multilayer tubes in Examples and Comparative Examples, each property was evaluated in accordance with the below criteria. The results thereof are also shown in Table 2 below.

### <Extrusion Molding Property>

Appearance of the multilayer tube produced by co-extrusion molding as described above was visually observed and evaluated in accordance with the below evaluation criteria.

### <Evaluation Criteria>

∘ (very good): no layer disturbance between the inner layer and the outer layer, possible to obtain a tube with a specified thickness.
x (poor): layer disturbance occurred between the inner layer and the outer layer, impossible to obtain a tube with a specified thickness.

### <Interlayer Adhesion>

The multilayer tube produced by co-extrusion molding as described above was cut in half, and a strip-shaped test piece having a width of 10 mm was produced from the cut half tube. Then, the end of the test piece was peeled off by nippers, the peeled portion was grasped and pulled by a tensile tester at a speed of 25 mm/min to perform deamination. In this case, an average value of an adhesive strength (N/cm) when peel strength remained stable for 30 seconds was measured and indicated as “adhesive strength (N)”.

Additionally, for the value of the “adhesive strength (N/cm)” indicated as described above, the value in Example 4 was expressed as an index of 100, and the value of each “adhesive strength (N/cm)” was converted to an index based on the value in Example 4.

Then, the interlayer adhesion was evaluated in accordance with the below criteria.

### <Evaluation Criteria>

∘ (very good): value of the index is 70 or greater.
x (poor): value of the index is less than 70.

TABLE 2

| | | | | | | | | Comparative | | | |
|---|---|---|---|---|---|---|---|---|---|---|---|
| | | Examples | | | | | | Examples | | | |
| | | 1 | 2 | 3 | 4 | 5 | 6 | 1 | 2 | 3 | 4 |
| Material for inner layer | | (A) | (B) | (B) | (B) | (C) | (D) | (E) | (F) | (C) | (A) |
| Material for outer layer | | (a) | (a) | (b) | (c) | (c) | (a) | (a) | (a) | (d) | (e) |
| Average particle size of organic particle | | 0.1 | 2 | 2 | 2 | 3.6 | 10 | 11 | 0.05 | 3.6 | 0.1 |
| in inner layer (μm) | | | | | | | | | | | |
| Number of convex protrusions (per 100 μm) | | 20 | 15 | 13 | 12 | 7 | 2 | 1 | 22 | 6 | — |
| Extrusion molding property | | ○ | ○ | ○ | ○ | ○ | ○ | ○ | ○ | ○ | × |
| Interlayer adhesion | (N/cm) | 63 | 67 | 44 | 35 | 37 | 25 | 19 | 23 | 17 | — |
| | (Index) | 180 | 191 | 126 | 100 | 106 | 71 | 54 | 66 | 49 | — |
| | Evaluation | ○ | ○ | ○ | ○ | ○ | ○ | × | × | × | — |

According to the results shown in Table 2 above, the multilayer tubes in Examples consequently had the excellent extrusion molding property and exhibited good interlayer adhesion.

On the contrary, in Comparative Example 1, it was considered that the average particle size of the organic particles (ethylene-propylene copolymer particles) in the inner layer was too large, which caused a stress concentration area; therefore, desired interlayer adhesion could not be obtained. In Comparative Example 2, it was considered that the average particle size of the organic particles (ethylene-propylene copolymer particles) in the inner layer was too small and a sufficient anchor effect could not be obtained; therefore, desired interlayer adhesion could not be obtained. In Comparative Example 3, as the polyamide resin to be used as the material for the outer layer, a polyamide resin with a lower amine value than the one specified by the present disclosure was used; it was thought that this lowered a rate of chemical bond formation, and as a result, desired interlayer adhesion could not be obtained. In Comparative Example 4, as the polyamide resin to be used as the material for the outer layer, a polyamide resin with a higher amine value than the one specified by the present disclosure was used; as a result, residues of the molten resin (die drool) easily accumulated on a tip of a head of the extrusion molding machine, making it impossible to obtain a tube with specified thickness by extrusion molding, and also causing abnormal appearance of the tube.

Although specific embodiments of the present disclosure have been described in Examples above, Examples are for illustrative purposes only and are not to be construed as limitative. It is intended that various modifications apparent to a person skilled in the art fall within the scope of the present disclosure.

### INDUSTRIAL APPLICABILITY

The multilayer tube of the present disclosure can be preferably used as a radiator hose, a heater hose, an air conditioner hose, and the like, as well as a cooling tube of a battery pack for an electric automobile and a fuel cell vehicle. Additionally, the multilayer tube can also be used not only for an automobile, but also for any other transport machines (an industrial transport vehicle such as an airplane, a forklift, an excavator, and a crane, as well as a railway vehicle, etc.) or the like.

1. A multilayer tube comprising:
a layered structure in which a polypropylene resin layer and a polyamide resin layer are laminated in direct contact with each other,
wherein a polypropylene resin in the polypropylene resin layer is maleic anhydride-modified polypropylene, the polypropylene resin layer containing organic particles having an average particle size of 0.1-10 μm,
wherein a polyamide resin in the polyamide resin layer is a polyamide resin with an amine value of 15-100 mmol/kg, and
wherein the multilayer tube has a plurality of convex protrusions caused by the organic particles on a side of the polypropylene resin layer at an interface between the polypropylene resin layer and the polyamide resin layer.

2. The multilayer tube according to claim 1, wherein a height of the convex protrusions is in a range of 0.1-10 μm.

3. The multilayer tube according to claim 1, wherein the number of the convex protrusions in a straight-line distance at the interface between the polypropylene resin layer and the polyamide resin layer is 2-20 per 100 μm.

4. The multilayer tube according to claim 1, wherein a ratio of the organic particles in the polypropylene resin layer is 5-20% by mass.

5. The multilayer tube according to claim 1, wherein the organic particles consist of at least one of polyethylene and an ethylene-propylene copolymer.

6. The multilayer tube according to claim 1, wherein the polypropylene resin layer is an inner layer and the polyamide resin layer is an outer layer.

7. The multilayer tube according to claim 1, further comprising at least one additional layer formed on an outer peripheral surface of the polyamide resin layer.
